(19) United States
(12) Patent Application Publication
(10) Pub. No.: US 2004/0259626 A1
(43) Pub. Date: Dec. 23, 2004

(54) System and method for wireless gaming

(76) Inventors: Zakir Akram, Guelph (CA); Daniel Bartozzi, Guelph (CA); Tahir Akram, Guelph (CA)

Correspondence Address: FASKEN MARTINEAU DUMOULIN LLP, 4200 TORONTO DOMINION BANK TOWER, BOX 20 TORONTO-DOMINION CENTRE, TORONTO, ON, M5K 1N6, CA

(21) Appl. No.: 10/829,398

(22) Filed: Apr. 22, 2004

(30) Foreign Application Priority Data
Apr. 22, 2003 (CA) 2,426,236

(51) Int. Cl. G06F 19/00; G06F 17/00

(52) U.S. Cl. 463/17

(57) ABSTRACT

A system and method for wireless gaming using a wireless terminal over a wireless network, which includes: multiple occasions to verify that a player generally meets regulatory requirements; an access code to access wireless gaming and a separate personal identification number to access a prepaid account to authorize payment for wireless gaming; a verification of a player's funds, location and meeting jurisdictional age requirements at time of play; notifying a player when they have won; and providing various means for a player to verify that the player has won. For example, a player may verify that they have won by presentation of a prepaid credit account number used to play the winning game and the associated personal identification number; presentation of a reference number provided with winning notification and the wireless terminal used to play the game; or presentation of photo identification and wireless network account information for verifying ownership of the wireless terminal used to play the game.

### FIELD OF THE INVENTION

The invention relates to an improved system and method for wireless gaming, and in particular, to an improved system and a method for wireless access to government-run lotteries.

### BACKGROUND OF THE INVENTION

In a conventional government-run lottery system a printed paper ticket is issued to a player and the player must then use the paper ticket when establishing the game played, the numbers played, ownership of the winning ticket and proof for claiming winnings. In a conventional government-run lottery system, winnings may go unclaimed because either the holder of the winning ticket does not know that they have a winning ticket or they have lost or misplaced the winning ticket. Furthermore, problems may also occur regarding the ownership of a ticket as related to when, where and how a player may have obtained the ticket or the money that was used to purchase the ticket when playing, as it relates to a winning ticket that may be claimed.

Conventional government-run or otherwise regulated lottery systems are generally not available to players wanting to play lottery games via mobile wireless terminals such as cellular phones, PDAs or the like, wherein the wireless terminals are connected to a wireless network. This is due, at least in part, to the need to meet local regulatory requirements for these games. Regulatory requirements may include regulations regarding the eligible age of a player, the location of play, maintaining a player's privacy, and the like.

Notwithstanding the above, various methods for mobile game and lottery play have been proposed. One such method involves providing games to players using a mobile radio device over a mobile radio network wherein a central play station carries out games according to predefined game rules. In this method, a prepaid amount is stored in an account to be used to pay for wagers of differing amounts and winnings are correspondingly added to the account for a player in order for the player to recoup monies for future use and wagering. A player communicates using special short messages with the central play station that hosts various lottery games. Additionally, a mobile phone with a subscriber identity module (“SIM”) card can be used to identify a player and communicate directly with the central play station. The money from the account may also be stored on the SIM card to which fends can be paid by using standard means, and also by using credits from a phone card where a mobile phone is used. The instructions to play may also be stored on the SIM card and can further be received from the central play station.

Another method involves a mobile wagering system for providing access to casino gaming and sports booking that permits a gambler to place wagers using a mobile gaming unit through a wireless network Herein, the mobile gaming unit may provide location information so that availability of games can be blacked out in jurisdictions with legal restrictions on gambling or the like. The gambler may be positioned anywhere there is an established local gaming server and may be provided access to the local server along with the games available in the local server jurisdiction based on the location of the mobile gaming unit. In this system, the gambler also establishes a payment method through conventional means, such as a credit card or checking account for the purpose of paying for wagers and receiving winnings. The gambler' account is debited by the wagered amount and any winnings are credited to the account.

Conventional methods and systems have several limitations both individually and collectively. These methods typically involve a central play station or server that manages all data regarding the players, the available games a player can bet on and pay out of winnings according to the game rules administered by the central play station. Accordingly, third party games of chance or events such as state lotteries, horse races or football games can be bet on by a player, but generally only in a manner where the central play station acts as a “bookie”. In this case, the central play station typically pays out winnings directly to the player according to its own set rules for the event or game. Therefore, the player does not typically participate in the game or event based on the rules for that game or event and receives winnings disbursed by a separate game or event organizer such as government run lottery or the like.

Conventional methods and systems typically do not provide a sufficient system required to implement the availability of government-run lottery from wireless terminals, while meeting related regulatory and player's privacy requirements. While these systems may allow for play and pay scenarios, they typically do not adequately describe scenarios required for claiming winnings meeting the requirements of government-run lottery systems. Furthermore, conventional systems and methods lack sufficient network security requirements needed by third party lottery providers and government-run lottery systems which preclude use of public Internet network for communication as it exposes the lottery network to hackers and malicious attacks.

Given the foregoing, a need exists for a system and method for wireless gaming that overcomes at least some of the shortcomings of the prior art.

### SUMMARY OF THE INVENTION

It is therefore an object of the present invention to provide an improved system and method for wireless gaming that overcomes at least some of the problems identified above.

According to an embodiment of the invention, there is provided an improved system and method for wireless gaming that is intended to facilitate:

i. game/lottery play using mobile terminals such as cellular phones, personal digital assistants (PDAs), and the like;

ii. game/lottery play over a mobile network, such as a cellular network;

iii. the meeting of regulatory requirements such as those with regard to age of the player and location of play;

iv. game/lottery play of local, national and international lottery games;

v. that no winning goes unclaimed because winners are notified of their winnings;

vi. that a player does not lose their winning because they lost or misplaced a ticket; and

vii. that player privacy is preserved

More specifically, according to an embodiment of the invention, there is provided an improved method for wireless gaming using a wireless terminal over a wireless network, which includes: verifying and recording a player's age when providing general authorization to access a wireless lottery gateway; verifying a player's age when providing new prepaid credit to be maintained in a prepaid credit account associated with the player and used with the wireless lottery gateway, requiring entry of an access code to access the wireless lottery gateway through the wireless terminal; requiring entry of a personal identification number to access the prepaid credit account; determining a player's location based on the wireless terminal; allowing access to games based on a player's recorded age, determined location, and authorized access to the prepaid credit account; notifying a player when they have won; and providing means for a player to verify that the player has won by at least one of: presentation of a prepaid credit account number used to play the winning game and the associated personal identification number; presentation of a reference number provided with winning notification and the wireless terminal used to play the game; and presentation of photo identification and wireless network account information for verifying ownership of the wireless terminal used to play the game.

The method of this embodiment includes verification of a player's age on two occasions to satisfy regulatory restrictions regarding age. In this case, age is indicative of a typical regulatory restriction or requirement, however, other restrictions of a similar nature could generally be handled in a similar way. The method also limits access to both the lottery games and to the credit account via requiring entry of codes to provide two levels of security against unauthorized access by someone other tan the player. The method also provides for notification of a win and various ways to claim winnings that are more secure than conventional paper ticket systems.

According to another embodiment of the invention, there is provided a method for wireless gaming over a wireless network, the method including: determining and recording that a player is generally authorized to engage in lottery games and provisioning a wireless terminal with a lottery application program, the lottery application program including an access code; providing a registry of lotto cards, each lotto card including a lotto card number and a personal identification number and having a predetermined value, where, at the time of providing the lotto card to the player, a determination is made that the player is generally authorized to engage in the lottery games; requesting entry of the access code into the wireless terminal upon activation of the lottery application program; verifying the access code; allowing access to a lottery gateway through the wireless terminal and the wireless network based on the verification of the access code; determining if a lotto card number having value available has been registered for the wireless terminal and: if not, requesting entry of a lotto card number having value available and personal identification number associated therewith, verifying the lotto card number and personal identification number and registering the lotto card number for the wireless terminal; and if so, requesting entry of a personal identification number associated with a registered lotto card number and verifying the personal identification number; determining a value available for the registered lotto card number, determining a geographic location of the wireless terminal; and providing access to play one or more lottery games of one or more lottery game providers based on the recorded determination that a player is generally authorized to engage in lottery games, the determined location, and the value available for the registered lotto card number.

In a particular case, the determining and recording that a player is generally authorized to engage in the lottery games includes determining and recording the player's age.

In another particular case, the wireless lottery providers are lottery providers subject to governmental regulation.

In another particular case, the providing access to play one or more lottery games includes: receiving information regarding a game to be played and information required for the game; communicating the game to be played and the information required for the game to a lottery server of the one or more lottery providers; receiving confirmation information of the game played and the information transmitted from the lottery server; and recording the confirmation information in a database related to the lottery card number.

In this particular case, the method may further include communicating the confirmation information to the wireless terminal such that the confirmation information may be stored in two locations for additional security.

Also in this particular case, the method may further include: receiving information about winning plays from a lottery provider; and informing or notifying a winning player of their winning. Preferably, this notification includes periodically reminding the winning player to collect their winnings so that a winner does not lose the chance to collect due to time restrictions on collection. Further preferably, the lottery provider may be provided with information for verifying an identity of the winning player.

In the method of this embodiment, the winning player may verify their win to the lottery provider by at least one of: presentation of a lotto card used to play the winning game and the associated personal identification number; presentation of a reference number provided with winning notification and the wireless terminal used to play the lottery game; and presentation of photo identification and wireless network account information. Thus, a winner may claim winnings even if a lotto card and/or wireless terminal are lost or stolen.

In yet another particular case, the wireless terminal is provisioned for game play by an authorized dealer at the time the wireless terminal is first provided to the player. Thus, wireless network providers may pre-provision wireless terminals for promotional or other purposes.

Preferably, the access code may be changed by the player and the lottery application program includes a graphical user interface.

According to another embodiment of the invention, there is provided a wireless gaming system for playing lottery games over a wireless network including: a lottery application program for running on a wireless terminal for allowing access to the wireless gaming system upon entering a valid access code on the wireless terminal; a lotto card including a lotto card number and a personal identification number; a wireless lottery services gateway in communication with the wireless terminal and lottery application program through the wireless network, the wireless lottery services gateway including: means for communicating with at least one of the wireless terminal and the wireless network to determine a geographical location of a player; and a mobile lottery terminal gateway in communication with the wireless lottery services gateway and with a lottery server for a lottery game, the mobile lottery terminal gateway including: a database for storing lotto card numbers, personal identification numbers and game play information; means for verifying the personal identification number prior to play; and means for communicating with the lottery server to conduct lottery game play; and means to determine lotteries that the player is authorized to play and to provide information about such determined lotteries to the wireless terminal for the player to play.

Preferably, the mobile lottery terminal gateway, and thus, the wireless gaming system, appears substantially the same as a conventional lottery terminal of each lottery server to each lottery server involved.

In various particular cases, the wireless gaming system may also include the lottery server for a lottery game, the wireless network and/or the wireless terminals. This will depend on the particular entity providing the wireless gaming system and on the overall configuration of the wireless gaming system as will be known to one of skill in the art.

In another particular case, the wireless lottery services gateway may further include a database for storing wireless terminal identifiers and associated access codes. In this way, access to the lottery application program may be controlled at either the wireless terminal or wireless lottery services gateway level.

In another particular case, the lotto card may further include a bar code and human readable code representing the lotto card number in order to allow scanning or reference to the lotto card number. Preferably, the personal identification number is physically detachable from the lotto card and lotto card number so that the lotto card cannot be used by a third party if lost or stolen.

According to another embodiment of the invention, there is provided a wireless gaming system for playing lottery games over a wireless network using a wireless terminal in communication with the wireless network, the wireless gaming system including: a wireless lottery gateway that is in communication with the wireless network and a lottery server; a lottery application program on the wireless terminal, wherein provisioning of the lottery application program to the wireless terminal includes recording of a user's age; means for allowing the wireless terminal to access the wireless lottery gateway only upon entry of and verification of an access code associated with at least one of the wireless terminal and the lottery application program; means for entering prepaid account information into the wireless terminal for storage in the wireless lottery gateway for future game play, the prepaid account information including a prepaid account number and a personal identification number; means for distributing lotto cards, each lotto card including a lotto card number and a personal identification number, the means of distributing further including means for determining that a player is generally authorized to engage in lottery games; means for determining a location of the wireless terminal; means for allowing the wireless lottery gateway to securely access one or more lottery servers that host one or more lottery games; means for allowing a user of the wireless terminal to select a lottery game to play based on the recorded user's age, the determined location, and verification of a valid personal identification number for a prepaid account associated with the wireless terminal; means for recording game information about a lottery game played by the user on at least one of the wireless lottery gateway and the mobile terminal to later determine if a user of the wireless terminal is a winner of a lottery game played; means for determining if a user of the wireless terminal is a winner of a lottery game played; and means for notifying the winner to collect winnings.

In a particular case, the wireless lottery gateway may includes: a wireless lottery services gateway in communication with the wireless terminal through the wireless network, the wireless lottery services gateway including a database for recording at least the user's age and also including means for interfacing with the wireless network provider and the means for determining a location of the wireless terminal through communication with at least one of the wireless terminal and the wireless network; and a mobile lottery terminal gateway in communication with the wireless lottery services gateway and to a lottery server for a lottery game, the mobile lottery terminal gateway including a database for storing prepaid account information and recording game information, means for verifying at least one of the prepaid account number and the personal identification number and means for communicating with the lottery server to conduct lottery game play, wherein the wireless lottery services gateway and the mobile lottery terminal gateway are separate and maintain separate databases for user information and for prepaid account and game information, respectively to provide a division between a user's personal information and gaming information to protect user privacy.

### BRIEF DESCRIPTION OF THE DRAWINGS

These and other features of the preferred embodiments of the invention will become more apparent in the following detailed description in which reference is made to the appended drawings wherein:

FIG. 1 illustrates a wireless gaming system according to an embodiment of the invention;

FIGS. 2a and 2b illustrate a pouch for containing a lotto card and a lotto card removed from the pouch showing a label sticker for a PIN number, respectively;

FIG. 3 illustrates another example of a lotto card with detachable portion for a PIN number;

FIG. 4 illustrates a wireless terminal display during entry of an access code (Nokia is a trademark);

FIG. 5 illustrates a wireless terminal with a display illustrating an example of a lotto menu (Ericsson is a trademark);

FIG. 6 illustrates a wireless terminal with a display illustrating an example of a lotto menu (Nokia is a trademark);

FIG. 7 illustrates a wireless terminal display during entry of a PIN number (Nokia is a trademark); and

FIG. 8 illustrates a wireless terminal display exemplifying a game verification/registration number (Nokia is a trademark).

### DESCRIPTION OF THE PREFERRED EMBODIMENTS

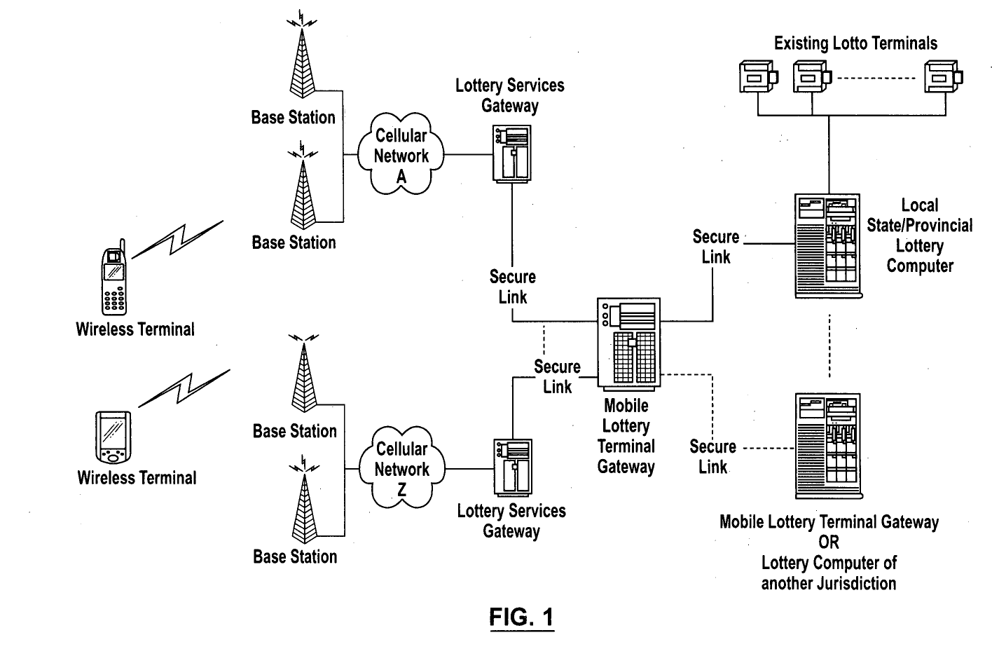

FIG. 1 illustrates a wireless gaming system (“WGS”) according to an embodiment of the invention. As shown in FIG. 1, the WGS may include a wireless terminal, a wireless lottery services gateway, a mobile lottery terminal gateway, a state/provincial lottery server or other lottery server (collectively “lottery server”), and lotto terminals. The wireless terminal can connect to the wireless lottery services gateway via a conventional wireless network and the wireless lottery services gateway is connected to the mobile lottery terminal gateway by a secure communication link. The mobile lottery terminal gateway is connected to the lottery server by a secure communications link. The lottery server is also connected to conventional lotto terminals via a secure link. The elements of the WGS are described in the following sections and a description of a method of using the WGS is also provided.

The wireless terminal is used to access and play a lottery through the wireless network and WGS. The wireless terminal may be a cellular telephone, a personal digital assistant (PDA) or similar device. The wireless terminal will typically have a display and keypad function and preferably also has an ability to store and run a lottery application program that can be loaded onto the wireless terminal. The wireless terminal also has a wireless Terminal identifier such as a telephone number, electronic serial number (ESN), subscriber identity module (SIM) number or the like. The wireless terminal is preferably connected to a conventional wireless network through a wireless service provider, such as, for example, a cellular network.

Through the lottery application program, the wireless terminal allows interaction with a user locally for the selection and play of a lottery game, moreover, it should be noted that, in a preferred embodiment, the wireless terminal communicates only indirectly with a lottery server.

Preferably, each wireless terminal may be associated with an access code required to run the lottery application program and/or connect to the wireless lottery services gateway.

As illustrated in FIG. 1, the wireless lottery services gateway is in communication with the wireless network. The wireless lottery services gateway may be used to validate a user or player (hereinafter “player”) to play lottery games using the wireless terminal. For example, the wireless lottery services gateway may include a database for storing each wireless terminal identifier registered for lottery play or for storing player information such as a player's age. The wireless lottery services gateway may also provide location information of a player when required, by, for example, having the location of a player determined using any of various network or handset/terminal based methods (for example, GPS methods) or by determining the location of the nearest receiving cell tower through the player's network service provider. The location of a player is used to assist in the selection of the lottery games that are made available for play to a player.

Preferably, the wireless lottery services gateway is associated with a telephone number or network address or the like to facilitate connection with the wireless terminal.

Preferably, the wireless lottery services gateway will not track information with respect to the amount of money a player has spent playing using the WGS, thereby preserving a player's privacy. However, the wireless lottery services gateway may notify the network service provider that the wireless terminal has been provisioned for and/or used for wireless gaming for the network services provider's billing purposes.

It will be understood that separate wireless lottery services gateways may be required for different wireless network providers, depending on, for example, the wireless technologies used and business or security needs.

As further illustrated in FIG. 1, the mobile lottery terminal gateway is in communication with the wireless lottery services gateway. The mobile lottery terminal gateway is also in communication with one or more lottery servers, preferably in a similar manner as a conventional lotto terminal. The mobile lottery terminal gateway provides games offered by the lottery servers to authorised players according to regulations and policies of the jurisdiction that a respective lottery server is operated in. Therefore, the mobile lottery terminal gateway may control the games that are made available to a player to be played depending on the player's location and any regulations and/or policies that govern the lottery server hosting the game. The mobile lottery terminal gateway will generally not implement and host any lottery game itself.

It will be understood that separate mobile lottery terminal gateways may be provided for separate jurisdictions, depending on, for example, the technologies used and business or security needs. In a case where there are a plurality of wireless lottery services gateways and/or mobile lottery terminal gateways it is preferable that these elements are in communication.

The mobile lottery terminal gateway includes a database that registers one or more lotto cards (as further described below) and preferably associates lotto cards with a wireless terminal identifier, such as a telephone number and/or an electronic serial number (ESN) and/or a subscriber identity module (SIM) number, of a wireless terminal used when registering a lotto card to allow a player to use the WGS. The mobile lottery terminal gateway may also store information related to authorization to play such as a player's age.

The mobile lottery terminal gateway also manages the use of the lotto card as payment for games played by a player in conjunction with the wireless lottery services gateway. Accordingly, the mobile lottery terminal gateway may draw down the amount of credit or value associated with the lotto card for games paid by the lotto card. Additionally, the mobile lottery terminal gateway records information about each play by a player when processing a game with a lottery server for registration of the play. The mobile lottery terminal gateway may, for example, register a reference number or the like as provided by a lottery server or the like in order to determine which player should be notified for winnings. The mobile lottery terminal gateway may also confirm with a user's wireless terminal, registration of play and the reference numbers, once these matters are confirmed by the lottery server.

Additionally, the mobile lottery terminal gateway may manage the winning of a free lottery game or cash by recording and conveying information included in the reference number of a winning play to a player's wireless terminal and may inform the player of their winnings. The mobile lottery terminal gateway may further interact with a lottery server or lottery provider to validate winnings being claimed at a lotto office or any other authorized lottery retail terminal.

Preferably the mobile lottery terminal gateway does not track or require the name, address or other identifying information of a player for the player to access the WGS, thereby helping to preserve a player's privacy.

Although the wireless lottery services gateway and mobile lottery terminal gateway are preferably separate in terms of databases for privacy and practical considerations, they may collectively be referred to herein as a wireless lottery gateway.

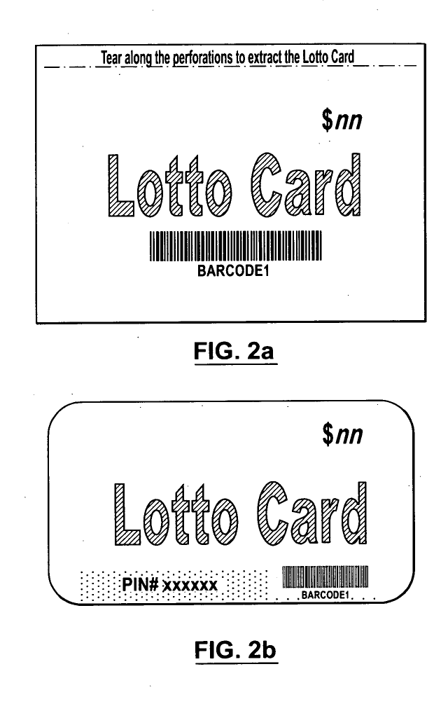

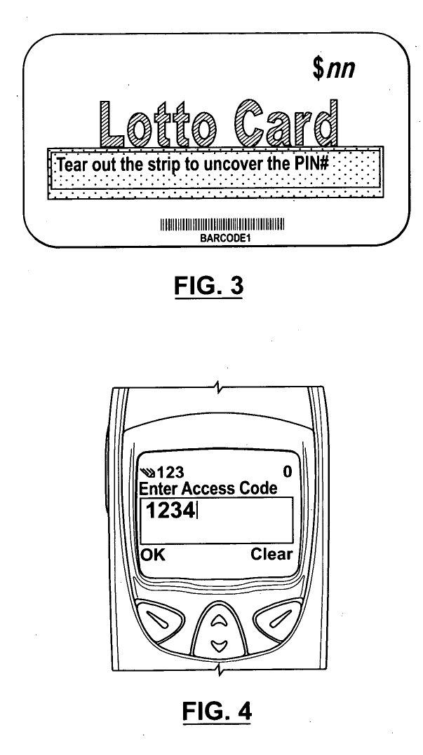

FIGS. 2A, 2B and 3 illustrate various embodiments of a lotto card and method of distribution. More specifically, FIG. 2A illustrates a pouch that may be used to distribute a lotto card and FIG. 2B illustrates a lotto card that is distributed in the pouch. FIG. 3 illustrates an alternate lotto card in which a PIN number is on a removable strip. It will be understood that other methods such as scratch off material could be used.

The lotto card as illustrated in FIGS. 2B and 3 provides mechanisms of payment for lottery games over a wireless network by using lotto credits on the lotto card. Lotto credits, dollar amounts, or some other value may be attributed to a lotto card and may, for example, represent currency of any country or organization where the WGS may be used or may represent game play units or some other value. In one preferred embodiment of the invention, the lotto card may not be re-charged or winnings credited to it. Accordingly, the lotto card is a prepaid card having a pre-determined value used to pay for lottery play through the WGS.

Lotto cards may be provided by a regulated lottery corporation or some other legitimate entity in order to pay for lottery games offered by the state/provincial lottery corporation and/or may be provided by an independent authority allowing for payment of games offered by different state/provincial lottery corporations, in addition to lottery games offered in various jurisdictions worldwide. However, lotto cards are preferably registered with the mobile lottery terminal gateway by the distributor for validation purposes. It is understood that lotto cards will preferably only be sold in approved areas in compliance with jurisdictional regulatory requirements such as age restrictions or the like.

As illustrated in FIG. 2B, a personal identification (PIN) number in conjunction with a lotto card number may be provided with the lotto card. Preferably, the PIN number and lotto card number are used to authenticate the lotto card and the amount of credits remaining on or associated with the lotto card in order for a player to use the lotto credits on the lotto card while playing various lottery games on the WGS. The PIN number on the lotto card is preferably detachable, such that the PIN number may be stored in a safe place separate from the lotto card, thus making the lotto card unusable by anyone except the person who knows both the lotto card number and the associated PIN number. An additional benefit with respect to a lotto card having a lotto card number as well as a PIN number is that once the lotto card has been registered, if there are lotto credits left on the lotto card, they may be used even when the physical card is lost or stolen as long as the PIN number is retained by the player, since other identifying features are retained by the wireless gaming system. As such, the registered lotto card number is a prepaid account number and the PIN number provides access to credit in the prepaid account

Since a lotto card is used with a PIN number it can be used to claim winnings for games paid for by that lotto card. Further, if someone finds a lost lotto card or steals one, the lotto card on its own may not be used because the associated PIN number of the lotto card is detachable and stored separately.

The lottery application program is stored and runs on the wireless terminal and is used by a player to play lottery games. The lottery application program may be created in any of many programming languages or may be implemented as a hardware element or the like. The lottery application program provides a player with a friendly interface with which to play one or more types of lotto games on the wireless terminal. Additionally, the lottery application program preferably also provides a user-friendly way in which a player may register a new lotto card for playing available games in a jurisdiction. The lottery application program may include a graphical user interface (“GUI”), which will assist in guiding the player in their game play. The lottery application program also provides a means for allowing play of a lottery game by legitimate users only and not by unauthorized individuals such as a minor or a person finding a wireless terminal. Accordingly, the lottery application program is preferably programmed to connect to a wireless lottery services gateway upon application start-up and only function after an access code is entered by an authorized player.

Since the WGS may offer local, national and/or international lottery games on the WGS by interfacing with lottery computers of different local, national and/or international lottery organizations in any jurisdiction, the lotto application program may further assist in providing access to lottery games based on the location of a player.

In a particular case, the lottery application program or WGS may store or relate the lotto card number with the wireless terminal for subsequent play, thus safeguarding the player if the lotto card is lost. This is a benefit To the original purchasing player since the lottery application program can store records about lotto cards and games played and the associated registration numbers that may then be accessed by entering a PIN number even if the lotto card is lost or stolen.

After a player has played a game and the lottery draw or result is determined, a player will be advised when they have won a game by the WGS. Accordingly, the player may have the option to choose how they would like to be informed of their winnings and the amount of their winnings. Various forms of communication to the player may be used, including e-mail, telephone, short message service (SMS), regular mail or The like.

Winnings may be claimed in various ways by a player, depending on jurisdictional regulations or policies, winnings may be claimed: (a) at a lotto authorized retailer, (b) at a lotto or organization-identified office, or (c) in the form of a bank cheque. In this last case, the player may request a cheque be sent directly to their registered address. Each of the foregoing methods of payment may be dependent on the amount of money to be collected by the player. For example, lotto authorized retailers may allow a user to claim winnings below a specified amount while a lotto or organization-identified office may deal with winnings above a specified amount, depending on the lottery rules.

Unlike conventional lottery systems relying on the paper ticket as proof of play and to claim the winnings, a player using the WGS system does not loose their ability to collect their winnings if a ticket is lost and also avoids other drawbacks in ticket-based systems. The winnings can be claimed in many ways such as: (a) by presenting the lotto card used to play the winning game and providing the associated PIN number when requested, (b) by presenting the reference number of the winning game and the wireless terminal used to play, or (c) by a photo identification and wireless network subscriber information in the event the player is not able to provide the PIN number associated with the lotto card or the wireless terminal has been lost. Additionally, if someone finds a registered player's wireless terminal or steals one, they will not be able to claim any winnings because they will not have the access code or the PIN number used with the lotto card to pay for the winning game. Additionally, an access code is required to allow them to get into the lottery application program for retrieving the reference number of the winning game played from that particular wireless terminal. Similarly a person finding a lost lotto card would not be able to provide the associated PIN number for claiming any winnings associated with the lotto card.

The amount spent by a player may be tracked by the mobile lottery terminal gateway. Herein, the player's identity will preferably not be known to the mobile lottery terminal gateway but is known to the network service provider. The network service provider, however, will not be able to track the amount that a given player has spent as this will be tracked by the mobile lottery terminal gateway. Thus, the mobile lottery terminal gateway will track the amount of money spent by a given player without knowing the exact identity of the player, such as their name, address and the like. This further maintains the privacy of a player playing the WGS. Additionally, the WGS enhances the privacy aspect with respect to players as it reduces the need for a player to stand in line in a public place in order to play a state/provincial or other type of lottery game. Preferably, the WGS also maintains security of wireless networks and lottery servers by separating the wireless lottery services gateway and the mobile lottery terminal gateway.

The WGS is designed to be secure from hackers and intruders in that it does not utilize the public internet network for communications.

This embodiment provides the benefit that the wireless terminals used by players will not be required to communicate directly with a lottery server because the wireless terminals communicate with a wireless lottery services gateway and a mobile lottery terminal gateway that are responsible for the required interfacing with lottery servers as indicated herein.

Preferably, the complete network to support the WGS may be designed to appear to a lottery server as a conventional lottery retail terminal, thus requiring minimal or no change to a lottery corporation's lottery server system. Ultimately, the complete set-up of the WGS may appear as a retail terminal to the lottery server whether the wireless lottery services gateway and mobile lottery terminal gateway are separate or combined.

Wireless Gaming Method (“WGM”)

A wireless gaming method according to an embodiment of the invention will now be described with reference to FIGS. 4 to 8. Initially, a player will provision a wireless terminal such as a cell phone, PDA or a similar device, to play lottery games on a WGS by obtaining the lottery application program. The provisioning of a wireless terminal may be done by, for example, having the player visit their wireless network service provider by calling the customer service department of their wireless network service provider, by dealing with the administrator of the wireless gaming system. Preferably the lottery application program will be loaded onto the wireless terminal over the air. In order to help regulate the use of the WGS by authorized players, the age, address, other ID or the like of a purchasing player and wireless network subscriber information may be checked at the time that the player's wireless terminal is provisioned for game play.

After checking a player's age or the like, the provisioning of the wireless terminal includes the registration of the wireless terminal with the WGS and with the wireless network provider or the like and the installation and set-up of the lottery application program. By way of example, provisioning may include: (a) registering the player age and possibly other player-related information, electronic serial number (ESN) or subscriber identification module number (SIM) of a wireless terminal with the network lottery services gateway; (b) downloading a lottery application program into the wireless terminal; (c) enabling the wireless terminal for game play with the wireless network provider in a subscriber account or the like; (d) setting up a default access code for the lottery application program on the wireless terminal; (e) registering player age, associated ESN or SIM number of the wireless terminal and preferred method other than the default to inform of winnings with the mobile lottery terminal gateway.

The default access code set up by the network service provider may be changed at a later date to personalize the access code after the provisioning of the wireless terminal. The default access code may initially be, for example, the last four digits of the user's cell phone number.

Preferably the access code must be entered each time the lotto application is started on the mobile terminal to prevent unauthorized play by, for example, a minor with access to the mobile terminal. FIG. 4 shows a wireless terminal during entry of an access code. The access code may also be stored in a database at the wireless lottery services gateway.

The ESN or SIM and player identification (which may include the age and preferred method to inform the player of winnings, if specified) may also be stored in the wireless lottery services gateway. This information may also be provided to the mobile lottery terminal gateway for providing verification of winnings.

A wireless network service provider may provide access to lottery gaming for free or for a charge. Where a charge is to apply from the network service provider, the charge may be a monthly service fee or a per use fee that may be added onto the players wireless account. The wireless lottery services gateway may also be used to provide information to a service provider with respect to any charges on a per call/per game basis that may need to be charged to a player.

It will be understood that the network service provider and the WGS administrator may or may not be the same entity.

After a wireless terminal is properly provisioned a player purchases a lotto card from an authorized dealer to facilitate the payment for the playing of lotto games. An authorized lotto card dealer may check the age of a purchasing player at the time a lotto card is sold to a player by way of identification, such as a driver's license. Moreover, lotto cards should only be sold in approved areas in compliance with regulatory requirements.

A lotto card may be delivered to the purchasing player in such a way that the PIN number required for registration and use of the lotto card is on a secure and tamper proof detachable portion of the lotto card. In this instance, the PIN number required for registration may only be uncovered/exposed by the purchasing player. In this regard the PIN portion of the lotto card will also act as a security feature in that, if there is any sign of tampering with the lotto card such that the PIN number is prematurely exposed, the lotto card should not be sold or purchased. Upon removal of the PIN portion of the lotto card by the purchasing player, it may be stored in a safe location separate from the lotto card and/or the wireless terminal.

The lotto card may also include a denomination indication, a lotto card number and a barcode printed on the lotto card along with a human readable form of the bar code. The lotto card number itself may be used for inventory and distribution control and clearing or other such required purposes.

The bar code/lotto card number is preferably linked to the PIN number in the database maintained by the mobile lottery terminal gateway. Accordingly, the mobile lottery terminal gateway may register the lotto card after checking the validity of the entered lotto card and the PIN number.

After a player has their wireless terminal provisioned for game play and has purchased a lotto card the user/purchaser may then begin to play lottery games.

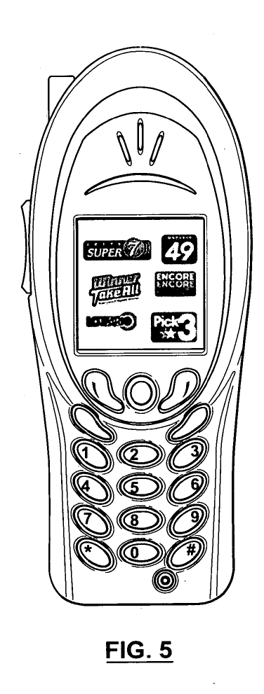

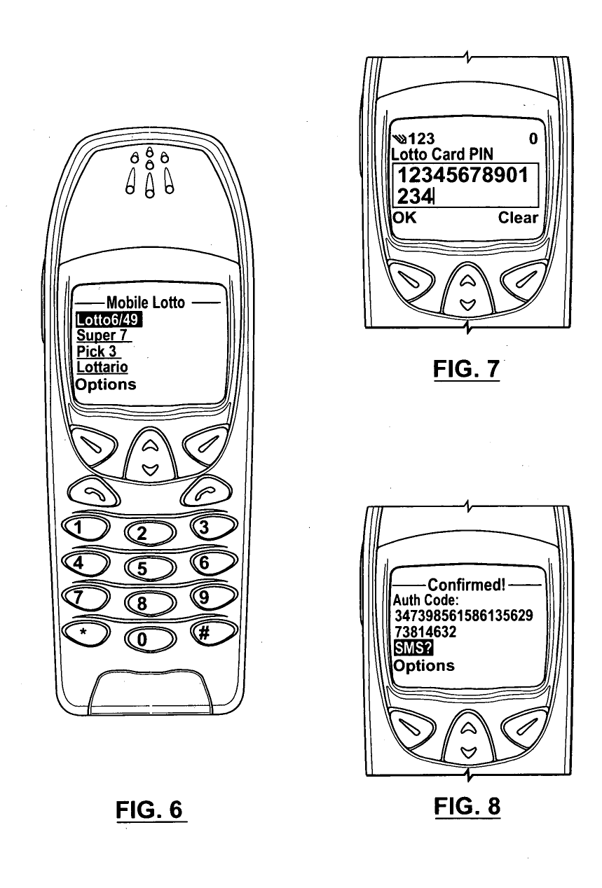

In order to play lottery games on the WGS, the player must first turn on the wireless terminal and start up the lottery application program by entering their access code. As described, the lottery application program may include a GUI that guides the player for data entry, game play and the like on their wireless terminal in order to allow the player to interact with the WGS. FIGS. 5 and 6 show wireless terminals displaying example lotto menus.

As previously described, the lottery application program links the wireless terminal to the lottery services gateway, through the player's network service provider to verify conditions, such as, that the wireless terminal is registered and authorized for game play and that the wireless terminal, and hence the player, are in an approved area for game play. Once verification of these conditions is met, the connection is passed on to the mobile lottery terminal gateway (which is connected to the lottery services gateway via a secure link) for further processing and game play.

When an individual first starts the lottery application program or when there are no valid lotto cards having remaining value for gaming maintained in the mobile terminal gateway database associated with a player's wireless terminal, the player is prompted via the lottery application program GUI to enter a new lotto cad and associated PIN number for registration and play since no balance will be available. The registration of the lotto card and its association with a wireless terminal, such as a player's cell phone ESN or SIM helps to protect against fraud and enable multiple ways in which a player may claim winnings (as described herein).

Preferably, a player does not have to enter the lotto card number each time a game is played after it is initially entered and only the entry of the associated PIN number required for game play may be needed, in order for the credit on the lotto card to be accessed, FIG. 7 shows a wireless terminal wing request and entry of a PIN number. Accordingly, the player may play games on the WGS until the pre-determined value of the lotto card is exhausted. In order to exhaust the value of the lotto card, it may take the player one or more sessions as the player's lotto card is debited with each play until there are no more credits left on the lotto card.

If a player wishes to change their provisioned wireless terminal, in order to use remaining credits on a lotto card, the player would have to re-register the lotto card, as described above, using the new wireless terminal. The mobile lottery terminal gateway registers the latest association of the lotto card with a wireless terminal. Preferably, only one wireless terminal may be used with each lotto card.

The lotto application may further allow the registration of more than one lotto card at any given time.

In addition to the foregoing, the WGS may include a check of the age and location of a player to determine if the player is in an approved area for a lottery game. The location of the player may be checked by receiving location information regarding the wireless terminal, such as a cell phone, from the cellular network service provider via the wireless lottery services gateway. This may also be done by other means available such as directly from a wireless terminal equipped with a global positioning system (GPS) unit, or the like.

Depending on the age and locale of a player, different games may be made available to the player and these are displayed on their wireless terminal for play. Accordingly, the choice of games presented to the player through the game menu on the wireless terminal may depend on the age of the player and area in which they are located. The games available may further be dictated, in part, by regulatory requirements.

The player then chooses a game and enters lottery numbers or required information in accordance with the rules of the game that the player has chosen to play. In particular, the lottery application program will guide the player in the entry of numbers and play of the game, in accordance with the rules of the chosen game or lottery.

After entry of play information, the mobile lottery terminal gateway may again verify the age and present location of a player (via the wireless lottery services gateway) in order to confirm the location of a player who is physically moving and thus may be present in a valid location at the start of access to the WGS, but may be in an invalid location at the time of submitting a game play request.

Thereafter, the mobile lottery terminal gateway communicates the game request to the appropriate lottery server. The communication between the mobile lottery terminal gateway and the lottery server is preferably by way of a secure link. Upon acceptance and registration of a play by a lottery server, the lottery server provides information or confirmation about the play, such as a unique reference number to the mobile lottery terminal gateway. The mobile lottery terminal gateway then stores the information about the play along with the player's wireless terminal/identifier, lotto card number or other information in a database for future reference. In particular, the player's information may include the lotto card and PIN number, the ESN/SIM number, game played, numbers selected and the player's age and location. The mobile lottery terminal gateway may also provide for similar play information to be stored in the player's wireless terminal for future retrieval. FIG. 8 shows a wireless terminal displaying a reference number related to a lottery play. It will be understood that the lottery organization and the mobile lottery terminal gateway administration may or may not be the same entity.

Next, a winning lottery number is drawn by the lottery organization. The mobile lottery terminal gateway then receives information on a winning number that is drawn for a particular game from the lottery server. The mobile lottery terminal gateway then compares the information that it receives against the stored plays for the same game in its database. Once the comparison is complete the winner or winners may then be determined and the mobile lottery terminal gateway or its administrators inform the winner and/or winners using one or more methods, and preferably one of the methods indicated by the player during the provisioning of their wireless terminal for lottery play, as previously described.

Any one or more of the following methods may be available to establish proof of ownership to claim a winning game, if required:

(a) the presentation of a lotto card used to play the winning game and the associated PIN number;

(b) the presentation of a reference number provided with winning notification and the wireless terminal used to play the lottery game; or

(c) the presentation of photo identification and wireless network provider subscriber information (that is, information related to the subscriber account with the wireless network provider to verify ownership of the wireless terminal that played).

The winner and/or winners of a lottery game may collect their winnings by, for example, visiting an authorized lottery retailer (typically, where the winnings are under a certain pre-determined amount). Upon visiting the authorized lottery retailer the winner may collect their winnings by presenting the authorized lottery retailer with necessary information such as that noted above.

The winner and/or winners may also receive their winnings by making a request via their wireless terminal to the mobile lottery terminal gateway administration that a cheque be sent to their registered home address, provided that winnings are under a certain pre-determined and/or amount this method of payment is permitted by regional lottery regulations in the jurisdiction that the player/winner resides and/or played. The winner may also collect their winnings from a lottery provider administration office (for example, if the winnings are over a certain pre-determined amount) or if the player/winner has lost and/or forgotten the PIN number of the lotto card and/or they have lost the wireless terminal that they used to play the winning game.

The mobile lottery terminal gateway administration may on a periodic basis continue to remind a winner of their unclaimed winnings whenever there are unclaimed winnings in the mobile lottery terminal gateway database.

The administration of the mobile lottery terminal gateway and the issuing authority for the lotto cards may be an independent organization from the lottery organizations that are connected to the WGS in order to provide the games. Additionally, the mobile lottery terminal gateway and the issuing authority for the lotto cards may be independent organizations from the cellular network service provider of the player's wireless terminal.

Some of the benefits of the WSG and WGM according to the embodiments of the invention are that:

the PIN number for the lotto card is detachable from the lotto card and may be stored separately from the lotto card, making the lotto card unusable to anyone that obtains only the lotto card;

the purchaser of the lotto card can use all of the credits/value associated with the lotto card even if the lotto card is lost or stolen before all of the money is used;

there is an access code needed to startup the lotto application on the wireless terminal which prevents unauthorized play by minors or others with access to the wireless terminal;

there may be a lottery application program running on the wireless terminal providing local interaction with the player to select, guide and play a lottery game without using touch-tones as an input;

the use of location information in the mobile environment may be used to restrict access to a particular game;

the WGS allows for checking the age of the players to help satisfy jurisdictional lottery regulations;

the mobile lottery terminal gateway can allow players with access to lottery games from multiple jurisdictions throughout the world;

winnings will be announced to a winner by the WGS and therefore there is less chance of winnings being unclaimed;

there may be multiple ways to inform a player of their winnings which if unclaimed can continue in a persistent fashion;

the system is ticketless allowing winnings to be claimed without the requirement of a “paper ticket” which, in conventional systems, if misplaced, lost or stolen cannot be redeemed by the original player who won the game;

the WGS only allows winnings to be claimed by the original player unlike the current available method in which if a “ticket” is lost or stolen someone other than the original player can claim the winning;

the WGS and WGM will serve to enhance player privacy.

It will be understood by one of skill in the art that the elements of the WGS may generally be implemented as software or hardware components or some combination thereof. It will also be understood that the functions of a particular element may be performed alternatively by a related element For example, where a wireless terminal has limited resources, such as memory, some of the functions of the lottery application program, such as verifying the access code, may be moved to the wireless lottery services gateway. Further, even though the terms server or gateway are used, these terms should be construed generally rather than in a narrow technical meaning.

Further, it will be understood that the WGS does not necessarily include and is not limited to the elements in the described embodiments. For example, where the wireless terminal and wireless network are already provided by a wireless network provider and the lotto servers are already provided by a lottery corporation or provider, a WGS may provide the lottery application program, the wireless lottery services gateway, the mobile gateway, and the lotto cards. Other combination and subsets may also be possible.

Although the invention has been described with reference to certain specific embodiments, various modifications thereof will be apparent to those skilled in the art without departing from the spirit and scope of the invention as outlined in the claims appended hereto.

We claim:

1. A method for wireless gaming using a wireless terminal over a wireless network, said method comprising:
verifying and recording a player's age when providing general authorization to access a wireless lottery gateway;
verifying a player's age when providing new prepaid credit to be maintained in a prepaid credit account associated with the player and used with the wireless lottery gateway;
requiring entry of an access code to access said wireless lottery gateway through the wireless terminal;
requiring entry of a personal identification number to access said prepaid credit account;
determining a player's location based on the wireless terminal;
allowing access to games based on a player's recorded age, determined location, and authorized access to said prepaid credit account;
notifying a player when they have won; and
providing means for a player to verify that the player has won by at least one of:
presentation of a prepaid credit account number used to play the winning game and the associated personal identification number;
presentation of a reference number provided with winning notification and the wireless terminal used to play the game; and
presentation of photo identification and wireless network account information for verifying ownership of the wireless terminal used to play the game.

2. A method for wireless gaming over a wireless network, said method comprising:
determining and recording that a player is generally authorized to engage in lottery games and provisioning a wireless terminal with a lottery application program, said lottery application program including an access code;
providing a registry of lotto cards, each lotto card including a lotto card number and a personal identification number and having a predetermined value, where, at the time of providing said lotto card to the player, a determination is made that the player is generally authorized to engage in said lottery games;
requesting entry of said access code into said wireless terminal upon activation of said lottery application program;
verifying said access code;
allowing access to a lottery gateway through said wireless terminal and the wireless network based on said verification of said access code;
determining if a lotto card number having value available has been registered for said wireless terminal and:
if not, requesting entry of a lotto card number having value available and personal identification number associated therewith, verifying said lotto card number and personal identification number and registering said lotto card number for said wireless terminal; and
if so, requesting entry of a personal identification number associated with a registered lotto card number and verifying said personal identification number;
determining a value available for said registered lotto card number;
determining a geographic location of said wireless terminal; and
providing access to play one or more lottery games of one or more lottery game providers based on said recorded determination that a player is generally authorized to engage in lottery games, said determined location, and said value available for said registered lotto card number.

3. The method according to claim 2, wherein said determining and recording that a player is generally authorized to engage in said lottery games comprises determining and recording said player's age.

4. The method according to claim 2, wherein said wireless lottery providers are lottery providers subject to governmental regulation.

5. The method according to claim 2, wherein said providing access to play one or more lottery games comprises:
receiving information regarding a game to be played and information required for the game;
communicating the game to be played and the information required for the game to a lottery server of said one or more lottery providers;
receiving confirmation information of the game played and the information transmitted from said lottery server; and
recording said confirmation information in a database related to said lottery card number.

6. The method according to claim 5, further comprising communicating said confirmation to said wireless terminal.

7. The method according to claim 5, further comprising:
receiving information about winning plays from a lottery provider; and
informing a winning player of their winning.

8. The method according to claim 7, further comprising:
periodically reminding said winning player to collect their winnings.

9. The method according to claim 7, further comprising:
providing the lottery provider with information for verifying an identity of said winning player.

10. The method according to claim 7, wherein said winning player verifies their win to the lottery provider by at least one of:
presentation of a lotto card used to play the winning game and the associated personal identification number;
presentation of a reference number provided with winning notification and said wireless terminal used to play the lottery game; and
presentation of photo identification and wireless network account information.

11. The method according to claim 2, wherein said wireless terminal is provisioned for game play by an authorized dealer at the time said wireless terminal is first provided to said player.

12. The method according to claim 2, wherein said access code can be changed by said player.

13. The method according To claim 2, wherein said lottery application program comprises a graphical user interface.

14. A wireless gaming system for playing lottery games over a wireless network comprising:
a lottery application program for running on a wireless terminal for allowing access to said wireless gaming system upon entering a valid access code on the wireless terminal;
a lotto card including a lotto card number and a personal identification number;
a wireless lottery services gateway in communication with said wireless terminal and lottery application program through said wireless network, said wireless lottery services gateway comprising:
means for communicating with at least one of said wireless terminal and said wireless network to determine a geographical location of a player; and
a mobile lottery terminal gateway in communication with said wireless lottery services gateway and with a lottery server for a lottery game, said mobile lottery terminal gateway comprising:
a database for storing lotto card numbers, personal identification numbers and game play information;
means for verifying said personal identification number prior to play; and
means for communicating with said lottery server to conduct lottery game play; and
means to determine lotteries that the player is authorized to play and to provide information about such determined lotteries to said wireless terminal for the player to play.

15. The wireless gaming system according to claim 14, wherein said mobile lottery terminal gateway appears substantially the same as a conventional lottery terminal of said lottery server to said lottery server.

16. The wireless gaming system according to claim 14, further comprising said lottery server for a lottery game.

17. The wireless gaming system according to claim 14, further comprising said wireless network.

18. The wireless gaming system according to claim 14, further comprising said wireless terminal.

19. The wireless gaming system according to claim 14, wherein said wireless lottery services gateway further comprises a database for storing wireless terminal identifiers and associated access codes.

20. The wireless gaming system according to claim 16, wherein said lottery server is in secure communication with one or more conventional lottery terminals.

21. The wireless gaming system according to claim 14, wherein said lotto card further comprises a bar code and human readable code representing said lotto card number.

22. The wireless gaming system according to claim 14, wherein said personal identification number is physically detachable from said lotto card and lotto card number.

23. A wireless gaming system for playing lottery games over a wireless network using a wireless terminal in communication with said wireless network, said wireless gaming system comprising:
a wireless lottery gateway that is in communication with the wireless network and a lottery server;
a lottery application program on the wireless terminal, wherein provisioning of said lottery application program to said wireless terminal includes recording of a user's age;
means for allowing said wireless terminal to access said wireless lottery gateway only upon entry of and verification of an access code associated with at least one of said wireless terminal and said lottery application program;
means for entering prepaid account information into said wireless terminal for storage in said wireless lottery gateway for future game play, said prepaid account information including a prepaid account number and a personal identification number;
means for distributing lotto cards, each lotto card including a lotto card number and a personal identification number, said means of distributing further comprising means for determining that a player is generally authorized to engage in lottery games;
means for determining a location of said wireless terminal;
means for allowing said wireless lottery gateway to securely access one or more lottery servers that host one or more lottery games;
means for allowing a user of said wireless terminal to select a lottery game to play based on said recorded user's age, said determined location, and verification of a valid personal identification number for a prepaid account associated with said wireless terminal;
means for recording game information about a lottery game played by said user on at least one of said wireless lottery gateway and said mobile terminal to later determine if a user of said wireless terminal is a winner of a lottery game played;
means for determining if a user of said wireless terminal is a winner of a lottery game played; and
means for notifying said winner to collect winnings.

24. The wireless gaming system according to claim 23, wherein said wireless lottery gateway comprises:
a wireless lottery services gateway in communication with said wireless terminal through said wireless network, said wireless lottery services gateway comprising a database for recording at least said user's age and also comprising means for interfacing with said wireless network provider and said means for determining a location of said wireless terminal through communication with at least one of said wireless terminal and said wireless network; and
a mobile lottery terminal gateway in communication with said wireless lottery services gateway and to a lottery server for a lottery game, said mobile lottery terminal gateway comprising a database for storing prepaid account information and recording game information, means for verifying at least one of said prepaid account number and said personal identification number and means for communicating with said lottery server to conduct lottery game play,
wherein said wireless lottery services gateway and said mobile lottery terminal gateway are separate and maintain separate databases for user information and for prepaid account and game information, respectively to provide a division between a user's personal information and gaming information to protect user privacy.
